(19) United States
(12) Patent Application Publication
(10) Pub. No.: US 2015/0100794 A1
(43) Pub. Date: Apr. 9, 2015

(54) METHOD FOR SIGNING A SET OF BINARY ELEMENTS, AND UPDATING SUCH SIGNATURE, CORRESPONDING ELECTRONIC DEVICES AND COMPUTER PROGRAM PRODUCTS

(71) Applicant: THOMSON LICENSING, Issy de Moulineaux (FR)

(72) Inventors: Marc JOYE, Palo Alto, CA (US); Benoit Libert, Cesson-Sevigne (FR)

(21) Appl. No.: 14/508,113

(22) Filed: Oct. 7, 2014

(30) Foreign Application Priority Data
Oct. 8, 2013 (EP) 13306390.9

(51) Int. Cl. H04L 9/32; H04L 9/30

(52) U.S. Cl. CPC H04L 9/3247; H04L 9/30
USPC 713/189

(57) ABSTRACT

In one embodiment, it is proposed a method for signing a set of binary element comprising n elements, where n is an integer, by an electronic device. Such method is remarkable in that it outputs a signature associated to the set, that can be derived by the use of the public key when one or several new elements are added to the set.

### TECHNICAL FIELD

The disclosure relates to cryptography, and more specifically, to homomorphic signature schemes.

### BACKGROUND

This section is intended to introduce the reader to various aspects of art, which may be related to various aspects of the present invention that are described and/or claimed below. This discussion is believed to be helpful in providing the reader with background information to facilitate a better understanding of the various aspects of the present invention. Accordingly, it should be understood that these statements are to be read in this light, and not as admissions of prior art. In this section, a focus on e-voting context is used in order to present some issues. However, one skilled in the art could transpose to other contexts in which similar issues occur (e.g. when authenticating sets are used).

In e-voting context, some issues related to the storage of ballots are tackled in the article entitled “Cryptographic Methods for storing ballots on a voting machine” by J. Bethencourt et al., published in the proceedings of the conference Network and Distributed System Security Symposium (NDSS) 2007. More precisely, it is proposed a primitive, called an History-Hiding Append-Only Signatures (HH-AOS), that can be viewed as a special case of an homomorphic signatures that allows one to sign a set of messages (e.g. a set of ballots) in such a way that anyone can subsequently derive a signature on arbitrary supersets of the original set (e.g. when a vote is added to a set of ballots). This primitive was shown to provide subliminal-free storage mechanisms for ballots in e-voting systems. Indeed, in order to prevent anyone from injecting subliminal information (e.g. by embedding this information in derived signatures), it is required that derived signatures be indistinguishable from original signatures on the resulting superset. The article of Bethencourt et al. mentions two instantiations of such primitive. However, the first one is a generic construction, based on any signature, where the public key has linear size in the maximal size of sets to be signed, and it requires that the signer determines an upper bound on the cardinality of sets when generating his key pair. Moreover, this construction is not free of subliminal channels: the reason is that it allows the party running the signature derivation algorithm to choose certain values pseudo-randomly (rather than truly randomly), which allows a distinguisher to infer some information on the derivation history of signatures. Hence, only the second construction is a subliminal-free HH-AOS.

However, only such second construction is proved unforgeable under the Diffie-Hellman assumption in the random oracle model. But, a security proof in the random oracle model is considered as heuristic arguments rather than real mathematical proof, due to the fact that, when a real instantiation is done (i.e. when the random oracle in the construction is substitute with a hash function (such as the SHA-3)) some issue can occur. For example, in the article entitled “The Random Oracle Methodology, Revisited”, by R. Canetti et al., published in the proceedings of the conference STOC'98, it was showed that a signature scheme can have a security proof in the random oracle model but no secure instantiation with a concrete hash function.

Hence, there is a need to obtain a subliminal-free HH-AOS with a security proof in the standard model instead of a security proof in the random oracle model. In the state of the art no such subliminal-free HH-AOS with a security proof in the standard model is known.

One skilled in the art, trying to obtain such subliminal-free HH-AOS with a security proof in the standard model, would have consulted the article entitled “Computing on Authenticated data: New Privacy Definitions and Constructions” by N. Attrapadung et al., published in the proceedings of the conference Asiacrypt 2012. Indeed, such article proposes, especially the section 5, a dual technique of an HH-AOS, that has a security proof in the standard model (such technique is dual in the sense that a signature allows one to publicly derive a signature on a subset (rather than a superset) of an initial set). However, it does not seem obvious for one skilled in the art to adapt such dual technique in order to obtain an HH-AOS with a security proof in the standard model.

The present disclosure overcomes such issue.

### SUMMARY

References in the specification to “one embodiment”, “an embodiment”, “an example embodiment”, indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

The present disclosure is directed to a method for signing a set of binary elements comprising n elements, where n is an integer, by an electronic device. Such method is remarkable in that it comprises:
a step of obtaining a one-time key pair comprising a private key corresponding to a random integer, and a public key corresponding to an element of a group raised to the power of said random integer;
a step of signing said public key with a structure-preserving signature method, delivering a first signature ;
a step of obtaining a first commitment on said public key, a second commitment on said first signature and a first non-interactive witness proof that said public key and said first signature verify equations of the structure preserving signature;
a step of obtaining a decomposition of said private key into a sum of n random integer, each random integer been associated to only one element of said set;
a step of signing each element in said set in function of a programmable hash function and a random integer which is associated to it, delivering, for each element in said set, a second signature comprising at least a first and a second elements, a combination of all of said second elements being linked to said public key;
a step of obtaining a third commitment on said first element, and a fourth commitment on said second element, for each second signature;
a step of obtaining a second non-interactive witness proof that a relationship exists between said first element and said second element;
a step of obtaining a third non-interactive witness proof that asserts that said combination of all of said second elements is being linked to said public key holds;
a step of outputting a signature of said set of binary elements comprising said first, second commitments, said first non-interactive witness proof, said third non-interactive witness proof, and for each binary element of said set, said third, fourth commitments and said second non-interactive witness proof.

Such method is remarkable in that it outputs a signature associated to said set, that can be derived by the use of the public key (and not the private key) when one or several new elements are added to said set.

In a preferred embodiment, the method for signing is remarkable in that said first, second, third and fourth commitments are Groth-Sahai commitments.

In a preferred embodiment, the method for signing is remarkable in that said programmable hash function is a Waters hash function.

In a preferred embodiment, the method for signing is remarkable in that said random integer x is comprised between zero and a prime number p, and said public key corresponds to X=g^{x}, where g is said element of said group.

In a preferred embodiment, the method for signing is remarkable in that said step of signing each element comprises:
a step of obtaining said at least first element by determining a value σ_{i,1}= [symbol] (mᵢ)^{ω}^{ᵢ}, where [symbol] is said programmable hash function, mᵢ is an element of said set of binary elements, and ωᵢ is said random integer associated to said element mᵢ;
a step of obtaining said at least second element by determining a value σ_{i,2}=g^{ω}^{ᵢ}; and in that said combination corresponds to a product of all the n values σ_{i,2} that is equal to said public key.

In a preferred embodiment, the method for signing is remarkable in that said relationship between said first element σ_{i,1} and said second element σ_{i,2} is the following one: e(σ_{i,1}, g)=e( [symbol] (mᵢ), σ_{i,2}).

In a preferred embodiment, the present disclosure is directed to a method for updating, by an electronic device, a signature of a set of binary elements comprising n elements, where n is an integer. Such method is remarkable in that it comprises:
a step of verifying that said signature of said set of binary elements comprises a first and a second commitment, a first non-interactive witness proof, a third non-interactive witness proof, and for each binary element of said set, a third and a fourth commitments and a second non-interactive witness proof;
a step of adding k binary elements to said set, where k is an integer, delivering an updated set of binary elements comprising n+k elements that are different from each other;
a step of obtaining n+k random integer, each random integer been associated to only one element of said set, and a sum of said n+k random integer being equal to zero ;
a step of modifying for each binary element of said set, said third and said fourth commitments in function of a random integer associated to a binary element;
a step of determining for each of the k binary added elements, a first signature comprising at least a first and a second element in function of a programmable hash function and a random integer which is associated to it;
a step of determining for each first signature a fifth commitment on said at least a first element, a sixth commitment on said at least a second element, and a fourth non-interactive witness proof that a relationship exists between said first element and said second element, said fifth and sixth commitments corresponding to said third and fourth commitments for said k additional elements, and said fourth non-interactive witness proof corresponding to said second non-interactive witness proof for said k additional elements;
a step of updating said third non-interactive witness proof;
a step of re-randomizing commitments and proofs.

Such method enables to publicly (i.e. without using the private key) derive a signature on any superset of a signed set. Such method is history-hiding in that each derived signature leaks no information about its derivation history. The proposed method is the first one to provide this history-hiding property while being validated by a security proof in the standard model of computation (rather than a heuristic model).

In a preferred embodiment, such method for updating is remarkable in that all commitments are Groth-Sahai commitments.

In a preferred embodiment, such method for updating is remarkable in that said programmable hash function is a Waters hash function.

According to an exemplary implementation, the different steps of the method are implemented by a computer software program or programs, this software program comprising software instructions designed to be executed by a data processor of a relay module according to the disclosure and being designed to control the execution of the different steps of this method.

Consequently, an aspect of the disclosure also concerns a program liable to be executed by a computer or by a data processor, this program comprising instructions to command the execution of the steps of a method as mentioned here above.

This program can use any programming language whatsoever and be in the form of a source code, object code or code that is intermediate between source code and object code, such as in a partially compiled form or in any other desirable form.

The disclosure also concerns an information medium readable by a data processor and comprising instructions of a program as mentioned here above.

The information medium can be any entity or device capable of storing the program. For example, the medium can comprise a storage means such as a ROM (which stands for “Read Only Memory”), for example a CD-ROM (which stands for “Compact Disc—Read Only Memory”) or a microelectronic circuit ROM or again a magnetic recording means, for example a floppy disk or a hard disk drive.

Furthermore, the information medium may be a transmissible carrier such as an electrical or optical signal that can be conveyed through an electrical or optical cable, by radio or by other means. The program can be especially downloaded into an Internet-type network.

Alternately, the information medium can be an integrated circuit into which the program is incorporated, the circuit being adapted to executing or being used in the execution of the method in question.

According to one embodiment, an embodiment of the disclosure is implemented by means of software and/or hardware components. From this viewpoint, the term “module” can correspond in this document both to a software component and to a hardware component or to a set of hardware and software components.

A software component corresponds to one or more computer programs, one or more sub-programs of a program, or more generally to any element of a program or a software program capable of implementing a function or a set of functions according to what is described here below for the module concerned. One such software component is executed by a data processor of a physical entity (terminal, server, etc.) and is capable of accessing the hardware resources of this physical entity (memories, recording media, communications buses, input/output electronic boards, user interfaces, etc.).

Similarly, a hardware component corresponds to any element of a hardware unit capable of implementing a function or a set of functions according to what is described here below for the module concerned. It may be a programmable hardware component or a component with an integrated circuit for the execution of software, for example an integrated circuit, a smart card, a memory card, an electronic board for executing firmware etc.

In another embodiment, the present disclosure relates to an electronic device comprising means for signing a set of binary elements comprising n elements, where n is an integer. Said means for signing being remarkable in that they comprise:
means for obtaining a one-time key pair comprising a private key corresponding to a random integer, and a public key corresponding to an element of a group raised to the power of said random integer;
means for signing said public key with a structure-preserving signature means, delivering a first signature;
means for obtaining a first commitment on said public key, a second commitment on said first signature and a first non-interactive witness proof that said public key and said first signature verify equations of the structure preserving signature;
means for obtaining a decomposition of said private key into a sum of n random integer, each random integer been associated to only one element of said set;
means for signing each element in said set in function of a programmable hash function and a random integer which is associated to it, delivering, for each element in said set, a second signature comprising at least a first and a second elements, a combination of all of said second elements being linked to said public key;
means for obtaining a third commitment on said first element, and a fourth commitment on said second element, for each second signature;
means for obtaining a second non-interactive witness proof that a relationship exists between said first element and said second element;
means for obtaining a third non-interactive witness proof that asserts that said combination of all of said second elements is being linked to said public key holds;
means for outputting a signature of said set of binary elements comprising said first, second commitments, said first non-interactive witness proof, said third non-interactive witness proof, and for each binary element of said set, said third, fourth commitments and said second non-interactive witness proof.

In another embodiment, such electronic device is remarkable in that said first, second, third and fourth commitments are Groth-Sahai commitments.

In another embodiment, such electronic device is remarkable in that said programmable hash function is a Waters hash function.

In another embodiment, the present disclosure relates to an electronic device comprising means for updating a signature of a set of binary elements comprising n elements, where n is an integer, said means for updating being characterized in that they comprise:
means for verifying that said signature of said set of binary elements comprises a first and a second commitment, a first non-interactive witness proof, a third non-interactive witness proof, and for each binary element of said set, a third and a fourth commitments and a second non-interactive witness proof;
means for adding k binary elements to said set, where k is an integer, delivering an updated set of binary elements comprising n+k elements that are different from each other;
means for obtaining n+k random integer, each random integer been associated to only one element of said set, and a sum of said n+k random integer being equal to zero;
means for modifying for each binary element of said set, said third and said fourth commitments in function of a random integer associated to a binary element;
means for determining for each of the k binary added elements, a first signature comprising at least a first and a second element in function of a programmable hash function and a random integer which is associated to it;
means for determining for each first signature a fifth commitment on said at least a first element, a sixth commitment on said at least a second element, and a fourth non-interactive witness proof that a relationship exists between said first element and said second element, said fifth and sixth commitments corresponding to said third and fourth commitments for said k additional elements, and said fourth non-interactive witness proof corresponding to said second non-interactive witness proof for said k additional elements;
means for updating said third non-interactive witness proof;
means for re-randomizing commitments and proofs.

In another embodiment, such electronic device is remarkable in that all commitments are Groth-Sahai commitments.

### BRIEF DESCRIPTION OF DRAWINGS

The above and other aspects of the disclosure will become more apparent by the following detailed description of exemplary embodiments thereof with reference to the attached drawings in which:

FIG. 1 illustrates the scope of one embodiment of the present invention;

FIGS. 2(a)-(d) present the main functions of a signature scheme according to one embodiment of the invention;

FIGS. 3(a)-(d) present the main functions of a signature scheme according to a second embodiment of the invention;

FIG. 4 presents a device that can be used to perform one or several steps of methods disclosed in the present document.

### DESCRIPTION OF EMBODIMENTS

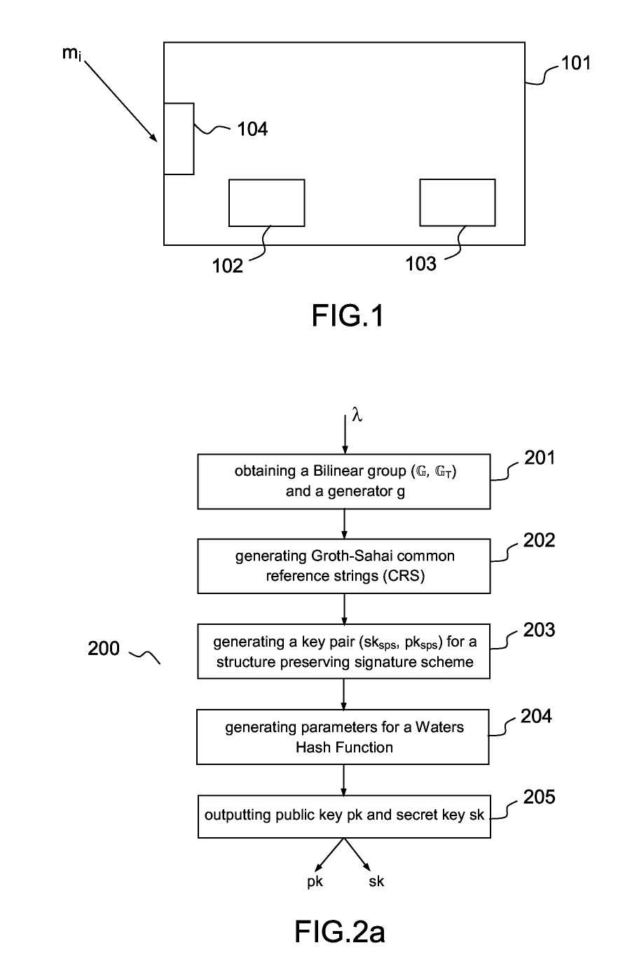

FIG. 1 illustrates the scope of one embodiment of the present invention.

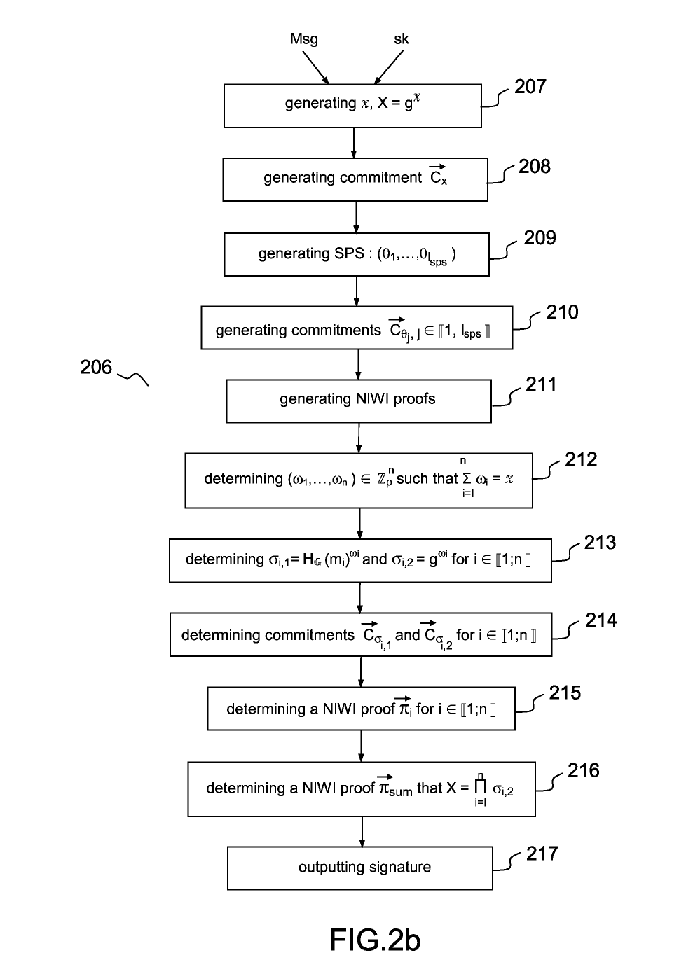

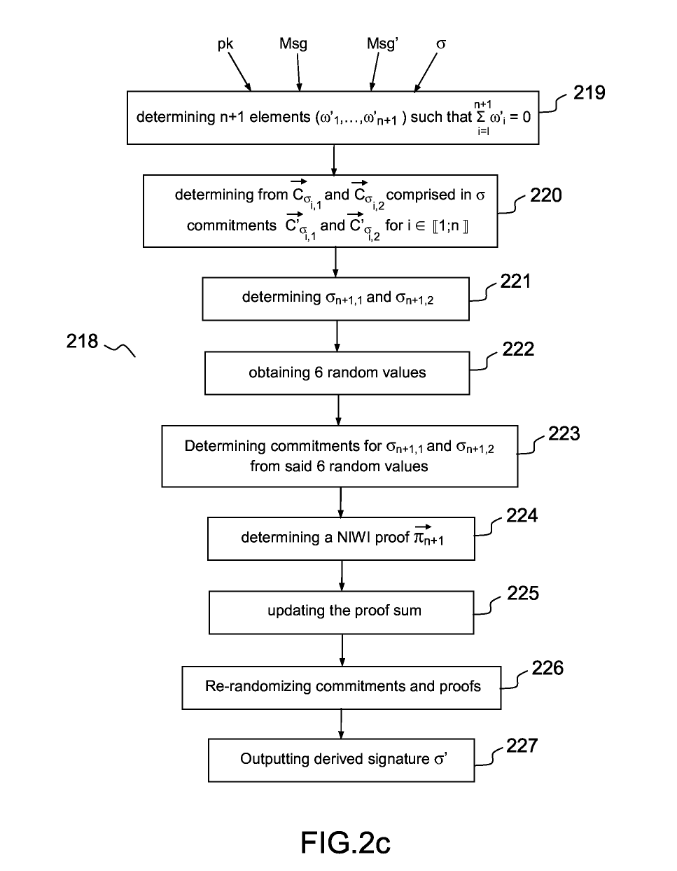

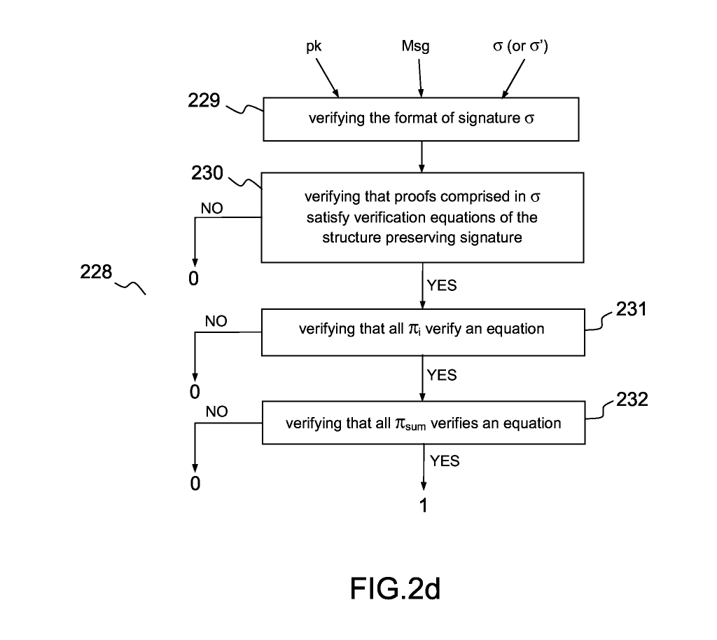

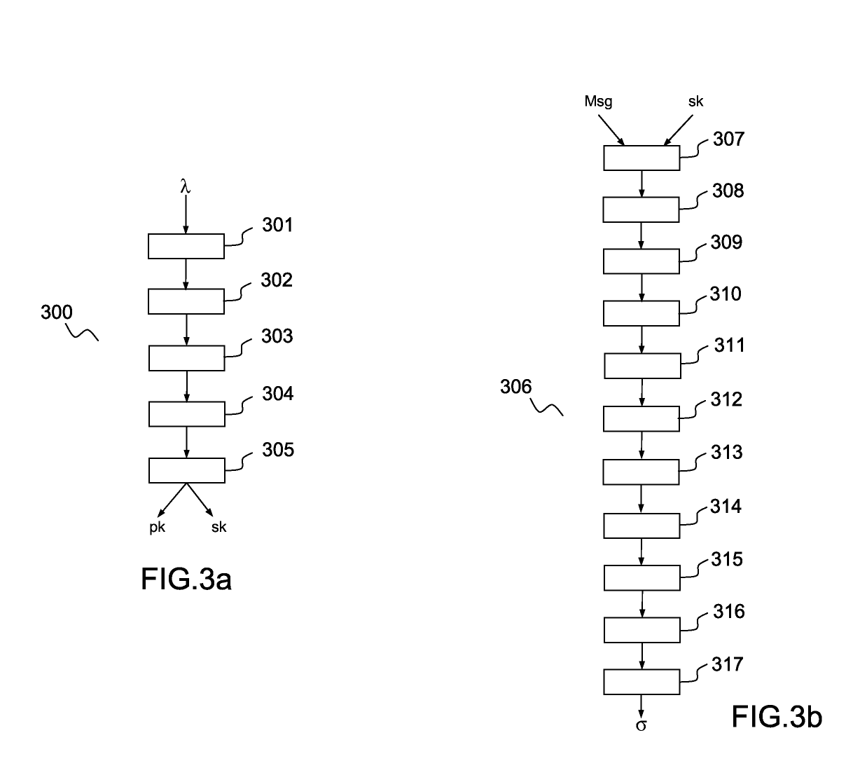

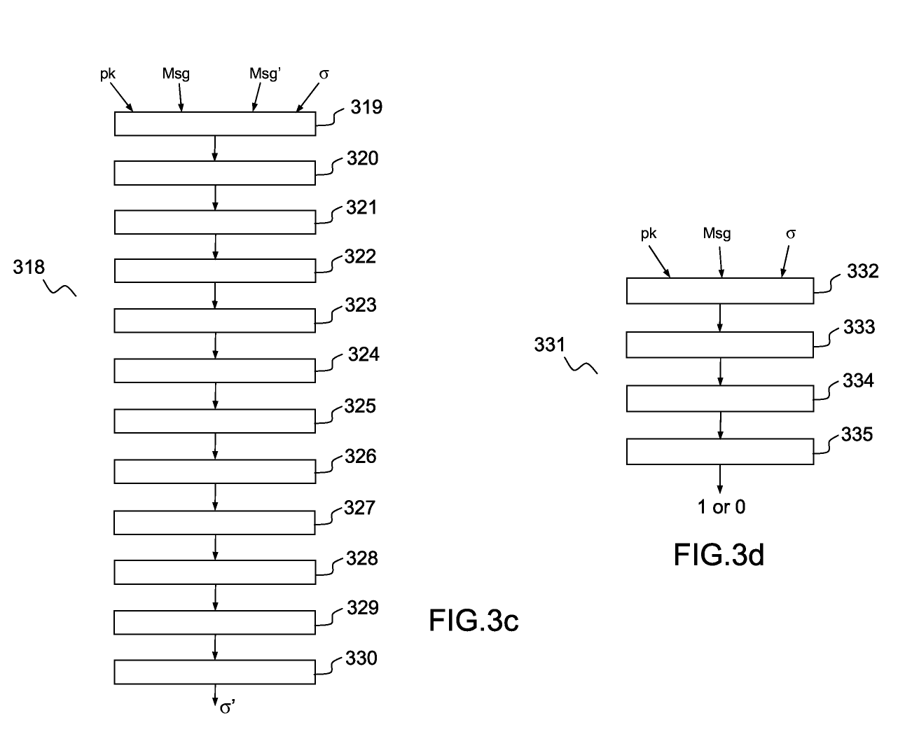

In such embodiment, an electronic device, referenced 101, and comprising a random generator unit, referenced 102, as well as memory unit, referenced 103, is able to store ballots. In order to manage the storage and the privacy of ballots during an electronic election, the electronic device 101 should be initiated as follow: it received from a trusted entity, a signed set via input/output means referenced 104. In one embodiment, the received set comprises at least one message. Such at least one message being a message corresponding to a “start” message (for example the such message m₁=0), and the received signature was determined according to one of the signature method described in the FIG. 2 or 3, via the use of a private key. The received message and the received signature are then stored into the memory unit 103. That this set and the associated signature that are going to be updated during an electronic vote. Indeed, when a voter has been identified and allowed to enter his vote (e.g. a message) via for example authentication means or via access control means, He votes on the electronic device 101. The electronic device 101 received in input a message m′ that can be for example m′=r ∥ vote, where r is a random value of 64 bits, and vote corresponds to the value of the vote. Then, the electronic device 101 checks if such message m′ already belongs to the stored set of ballots. In case that such message m′does not belong to such stored set, the electronic device adds to such set the received message (in that case for example m₂:=m′), and update the signature (without having a private key) associated to the modified set, that is still stored on the memory unit 103. In order to proceed to such update of signature, the electronic device 101 implements a signature derivation method as described in the FIGS. 2 and 3. When n voters have successively voted, the electronic device 101 stores, in the memory unit 103, the following set {mᵢ}ᵢ₌₁ⁿ as well as the associated signature. Let's remark that in another embodiment, several messages can be added at the same time (without having to iterate several time the derivation signature method).

The proposed signature technique that enables to obtain such kind of derivability of a signature is still compliant with the requirements of unforgeability, context hiding properties and prevent the occurrence of subliminal information. For reminders, the unforgeability captures the idea that if an attacker is given various derived signatures (perhaps iteratively derived) on messages of his choice, He should be unable to produce a signature on a message that is not derivable from the set of signed messages at his possession. The Context hiding requirement captures an important privacy property: a signature should reveal nothing more than the message being signed. In particular, if a signature on a message m′ was derived from a signature on m, the derived signature should be statistically indistinguishable from a fresh signature on m′, even if the original signature on m is revealed. This implies that an attacker should not learn anything about m other than what can be inferred from m′. This should be true even if the original signature on m is revealed.

FIGS. 2(a)-(d) and FIGS. 3(a)-(d) present respectively two embodiments of the present invention. These embodiments rely on the following features. It can be viewed as a non-obvious combination of some features described:
in the article “Computing on Authenticated Data: New Privacy Definitions and Constructions” by Attrapadung et al., published in the proceedings of the conference Asiacrypt 12, (which is exactly the dual primitive of the one considered in the present disclosure with the same privacy properties);
in the article “Unbounded HIBE and Attribute-Based Encryption” by A. Lewko and B. Waters, published in the proceedings of the conference Eurocrypt 2011. Indeed, the signature derivation algorithm of the present disclosure implicitly transforms an n-out-of-n additive secret sharing into a (n+1)-out-of-(n+1) additive sharing of the same secret. This transformation actually takes place in the exponent as the shares themselves are not directly available to the derivation algorithm. In the article of Lewko and B. Waters, a similar technique in the key delegation algorithm of their HIBE scheme is used. However, the present technique departs from the one described in such article in that the construction relies on the partitioning paradigm (i.e., the reduction is unable to sign certain messages that are used to solve a hard problem in the reduction). The reason is that, as pointed out in the article “Computing on Authenticated Data: New Privacy Definitions and Constructions” previously mentioned, these techniques make it harder to construct completely context-hiding schemes due to the existence of two or more distinct distributions of valid-looking signatures; and
in the article “Efficient Identity-Based Encryption Without Random Oracles” by B. Waters, published in the proceedings of the conference Eurocrypt 2005. Indeed, the present technique also relies on the programmability properties of the Waters hash function. For reminders, a programmable hash function is a number-theoretic hash function that emulates the behavior of random oracles in the standard model. As defined in the article “Programmable Hash Functions and Their Applications” by D. Hofheinz and E. Kiltz., and published in the proceedings of the conference Crypto 08, a programmable hash function maps a binary message m to a group element in such a way that the discrete logarithm of the hash value [symbol] (m) ε [symbol] (where [symbol] is a group) may be available or not with certain easy-to-assess probabilities. The number theoretic hash function described in the article “Efficient Identity-Based Encryption Without Random Oracles” maps a L -bit string m=m[1] . . . m[L] to the product [symbol] (m)=h₀.Πᵢ₌₁^{L}hᵢ^{m[i]} for uniformly distributed public group elements (h₀, . . . , h_{L}) ε_{R} [symbol] ^{L+1}. For any m ε {0,1}^{L}, it is possible to relate [symbol] (m) to exponents aₘ, bₘ ε [symbol] ₚ such that [symbol] (m)=g^{a}^{ₘ}h^{b}^{ₘ}. As defined in the previously mentioned article “Programmable Hash Functions and Their Applications”, a (m,n)-programmable hash function is a group hash function such that, for all X₁, . . . , Xₘ ε {0,1}^{L}, Z₁, . . . , Zₙ ε {0,1}^{L}, with Xᵢ≠Zⱼ the probability to have b_{X}_{₁}= . . . =b_{X}_{ₘ}=0 and b_{X}_{₁}≠0 [symbol] . . . [symbol] b_{X}_{_{m≠0}} is non-negligible. In the article “Efficient Identity-Based Encryption Without Random Oracles”, it was implicitly proved that Waters' hash function is (1, q)-programmable with probability

$$O ( \frac{1}{q} \cdot ( L + 1 ) ) .$$

If the Waters hash function is used to instantiate the Boneh-Lynn-Shacham signatures described in the article “Short Signatures from the Weil Pairing” by D. Boneh et al., and published in the proceedings of the conference Asiacrypt 2001 (for which a signature on m consists of [symbol] (m)^{sk}, where sk is the private key), this allows to prove its one-time unforgeability (i.e., its security in a game where the adversary is only allowed one signing query) in the standard model: the adversary's unique signing query m is answered by computing [symbol] (m)^{sk}=(g^{sk})^{a}^{ₘ} from the public key g^{sk} if bₘ=0. If the adversary forges a signature on a message m* for which b_{m*}≠0, the reduction can extract h^{sk}and thereby solve a Diffie-Hellman instance.

The idea of the present technique is to sign each set Msg={mᵢ}rᵢ₌₁ⁿ by generating a fresh one-time key pair (sk, pk)=(x, gx) ε [symbol] ₚ× [symbol] for a BLS-type signature. The one-time public key X=g^{x} is then certified using the long-term key pair of a structure-preserving signature scheme. Finally, the set Msg={mᵢ}ᵢ₌₁ⁿ is signed by choosing ω̅₁, . . . , ω̅ₙ [symbol] [symbol] ₚ such that Σᵢ₌₁ⁿ ω̅ᵢ=x and generating pairs (σ_{i,1}, σ_{i,2})=( [symbol] (mᵢ) ^{ω̅}^{ᵢ}, g ^{ω̅}^{ᵢ}) so that the verifier will have to check that Πᵢ₌₁ⁿ=σ_{i,2}=X and e(σ^{i,1}, g)=e( [symbol] (mᵢ), σ_{i,2}) for each i. By doing so, anyone will be able to publicly add new elements to the set by transforming the sharing { ω̅ᵢ}ᵢ₌₁ⁿ of x into a new sharing {ωᵢ′}ᵢ₌₁ⁿ⁺¹ of the same value. At the same time, as implied by the security proof, it is computationally infeasible to publicly remove elements from the signed set.

To guarantee the full context-hiding security of the scheme, we do not let pairs (σ_{i,1}, σ_{i,2}) appear in clear but replace them by perfectly-hiding Groth-Sahai commitments to (σ_{i,1}, σ_{i,2}) along with non-interactive witness indistinguishable (NIWI) proofs that committed values satisfy the appropriate relations (here, “witness indistinguishable” means that the proof leaks no information about which witnesses were used to generate them when several witnesses satisfy the proven relation).

The construction also makes use of structure-preserving signature schemes (as defined in the article “Structure-Preserving Signatures and Commitments to Group elements”, by M. Abe, G.

Fuchsbauer, J. Groth, K. Haralambiev, M. Ohkubo, in the proceedings of Crypto 2010, pp. 209-236). These are signature schemes where messages and public keys all consist of elements of an abelian group over which a bilinear map is efficiently computable. Specifically, a structure-preserving signature is used to certify a new one-time public key X=g^{x} when a new set is signed. To this end, the structure-preserving signature only has to be secure against random message attacks, where the adversary only obtains signatures on random messages that it has no control on.

FIGS. 2(a)-(d) present the main functions of a signature scheme according to one embodiment of the invention.

In the notations below, for any element h ε [symbol] and any vector \vec{g}=(g₁, g₂,g₃) ε [symbol] ³, E(h, \vec{g}) stands for the vector (e(h, g₁), e(h, g₂), e(h, g₃)) ε [symbol] _{T}³.

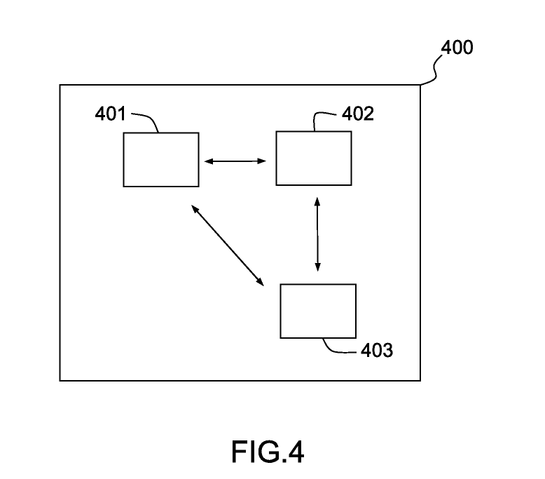

FIG. 2(a) presents a generation method noted Keygen(λ), referenced 200, that can be executed by a device as the one depicted in the FIG. 1 and FIG. 4. Such generation method comprises:
a step, referenced 201, of obtaining a bilinear group ( [symbol] , [symbol] _{T}) of prime order p>2^{λ}, with a generator g randomly chosen in the group [symbol] ;
a step, referenced 202, of generating a Groth-Sahai CRS f=(\vec{f₁}, \vec{f₂}, \vec{f₃}) for the perfect witness indistinguishability setting, namely \vec{f₁}=(f₁, 1, g), \vec{f₂}=(1, f₂, g) and \vec{f₃}=\vec{f₁}^{ε}^{₁}. \vec{f₂}^{ε}^{₂}. (1, 1, g)⁻¹, with randomly chosen elements f₁ and f₂ in the group [symbol] , and values ε₁ and ε₂, randomly chosen values in [symbol] ₚ;
a step, referenced 203, of generating a key pair (skₛₚₛ, pkₛₚₛ) for a structure-preserving signature scheme in order to sign messages consisting of a single group element. We denote by lₛₚₛ and vₛₚₛ the number of group elements per signature and the number of verification equations, respectively in this structure-preserving signature scheme;
a step, referenced 204, of generating parameters for a Waters hash function. Such step of generating comprises :
   a step of obtaining L+1 random values (h₀, h₁, . . . h_{L}) where each element hᵢ belongs to the group [symbol] ;
   a step of defining a function [symbol] :{0,1}^{L}→ [symbol] , such that for any L-bit string m=m[1] . . . m[L] ε {0,1}^{L}, we have [symbol] (m)=h₀.Πᵢ₌₁^{L}hᵢ^{m[i]}. In another embodiment, the message m is not decomposed in a base 2 as previously, but in a base than is strictly greater than 2. In that case, a different Waters hash function, as the one disclosed in the article “Trading Time for Space: Towards an Efficient IBE Scheme with Short(er) Public Parameters in the Standard Model” by S. Chatterjee et al., published in the proceedings of the conference ICISC 2005 or in the article “Secure and Practical Identity-Based Encryption” by D. Naccache, published on the Cryptology ePrint Archive Report 2005/369, is used. In another embodiment, another programmable hash function, that is based on the cover-free families, can be used (as the one depicted in the article : “Short Signatures from Weaker Assumption” by D. Hofheinz et al., published in the proceedings of the conference Asiacrypt 2011). Let's remark that all the deterministic programmable hash function can be used in such technique. These remarks can also be applied to the embodiment described in the FIG. 3;
a step, referenced 205, of outputting a public key pk which is defined as follows: pk=(( [symbol] , [symbol] _{T}), g, f, pkₛₚₛ, {hᵢ}ᵢ₌₀^{L}), and outputting a private key sk defined as follows: sk=skₛₚₛ. The public key defines Σ={0,1}^{L}.

In such embodiment, a Waters hash function [symbol] is used. But, in another embodiment, another programmable hash function can be used.

FIG. 2(b) presents a signature method noted Sign(sk, Msg), referenced 206, that can be executed by a device as the one depicted in the FIG. 1 and FIG. 4. Such signature method 206 takes on input a set of message Msg={mᵢ}ᵢ₌₁ⁿ, where mᵢ ε {0,1}^{L} for each i, and the private key sk=skₛₚₛ. Such signature method comprises:
a step, referenced 207, of generating a fresh one-time public key X=g^{x}, with an element x which is chosen randomly in the group [symbol] ₚ;
a step, referenced 208 of generating Groth-Sahai commitments \vec{C}_{X}=(1, 1, X). \vec{f₁}^{r}^{_{X}}. \vec{f₂}^{s}^{_{X}}. \vec{f₃}^{t}^{_{X}} with the elements r_{X}, s_{X} and t_{X} that are random values belonging to the group [symbol] ₚ;
a step, referenced 209, of generating a structure-preserving signature (θ₁, . . . , θₗ_{ₛₚₛ}) ε [symbol] ^{l}^{ₛₚₛ} on the group element X ε [symbol] ;
a step, referenced 210 of generating Groth-Sahai commitments C

$${\vec{C}}_{{θ}_{j}} = ( 1 , 1 , {θ}_{j} ) \cdot {\vec{f}}_{1}^{{r}_{{θ}_{j}}} \cdot {\vec{f}}_{2}^{{s}_{{θ}_{j}}} \cdot {\vec{f}}_{3}^{{t}_{{θ}_{j}}}$$

for j ε {1, . . . , lₛₚₛ};
a step, referenced 211, of generating NIWI proofs {\vec{π}_{sps,j}}ⱼ₌₁^{ν}_{ₛₚₛ} that committed variables (X, {θⱼ}ⱼ₌₁^{ₗ}_{ₛₚₛ}) satisfy the verification equations of the structure-preserving signature;
a step, referenced 212, of determining n elements of the group [symbol] ₚ, (ω₁, . . . , ωₙ), satisfying the following constraint: Σᵢ₌₁ⁿωᵢ=x;
a step, referenced 213 of determining for all the i ε {1, . . . , n} the followings values: σ_{i,1}= [symbol] (mᵢ)^{ω}^{ᵢ} and σ_{i,2}=g^{ω}^{ᵢ}, where the messages are indexed in some pre-determined lexicographical order;
a step, referenced 214, of determining commitments of said values σ_{i,1} and σ_{i,2} as follows:

$${\vec{C}}_{{σ}_{i , 1}} = ( 1 , 1 , {σ}_{i , 1} ) \cdot {\vec{f}}_{1}^{{r}_{i , 1}} \cdot {\vec{f}}_{2}^{{s}_{i , 1}} \cdot {\vec{f}}_{3}^{{t}_{i , 1}}$$

$$and$$

$${\vec{C}}_{{σ}_{i , 2}} = ( 1 , 1 , {σ}_{i , 2} ) \cdot {\vec{f}}_{1}^{{r}_{i , 2}} \cdot {\vec{f}}_{2}^{{s}_{i , 2}} \cdot {\vec{f}}_{3}^{{t}_{i , 2}} ,$$

for all the elements σ_{i,1} and σ_{i,2} that belong to the set {σ_{i,1}, σ_{i,2}}ᵢ₌₁ⁿ;
a step, referenced 215, of generating for all i ε {1, . . . , n}, a NIWI proof \vec{π}ᵢ proving that the elements σ_{i,1} and σ_{i,2} satisfy the equation e(σ_{i,1}, g)=e( [symbol] (mᵢ),σ_{i,2}). Such proof \vec{π}ᵢ is obtained by performing the followings computations: \vec{π}ᵢ=(π_{i,1}π_{i,2}, π_{i,3})=(g^{r}^{_{i,1}}, [symbol] (mᵢ)^{31 r}^{_{i,2}}, g^{s}^{_{i,1}}. [symbol] (mᵢ)^{-s}^{_{i,2}}, g^{t}^{_{i,1}}. [symbol] (mᵢ)^{-t}^{_{i,2}}) and satisfying the following equation :E(g, \vec{C}_{σ}_{_{i,1}})=E( [symbol] (mᵢ), \vec{C}_{σ}_{_{i,2}}). E(π_{i,1}\vec{f₁}).E(π_{i,2}, \vec{f₂}).E(π_{i,3}, \vec{f₃});
A step, referenced 216, of determining a NIWI proof \vec{π}ₛᵤₘ that X=Πᵢ₌₁ⁿσ_{i,2}. Such proof is obtained by performing the following computations:

$$\begin{matrix}{\vec{π}}_{sum} = ( {π}_{s , 1} , {π}_{s , 2} , {π}_{s , 3} ) \\ = ( {g}^{{r}_{X} - {\sum }_{i = 1}^{n} {r}_{i , 2}} , {g}^{{s}_{X} - {\sum }_{i = 1}^{n} {s}_{i , 2}} , {g}^{{t}_{X} - {\sum }_{i = 1}^{n} {t}_{i , 2}} ) ,\end{matrix}$$

which satisfies the equation

E(g, \vec{C}_{X}.Πᵢ₌₁ⁿ\vec{C}_{σ}_{_{i,1}}⁻¹)=E(π_{s,1}, \vec{f₁}). E(π_{s,2}, \vec{f₂}). E(π_{s,3}, \vec{f₃});
A step, referenced 217, of outputting the signature σ associated to the set of messages Msg={mᵢ}ᵢ₌₁ⁿ defined as:

σ=(\vec{C}_{X},{\vec{C}_{θ}_{ⱼ}}ⱼ₌₁^{l}^{ₛₚₛ}, {\vec{π}_{sps,j}}ⱼ₌₁^{ν}^{ₛₚₛ}, {(mᵢ, \vec{C}_{θ}_{_{i,1}}, \vec{C}_{θ}_{_{i,2}}, \vec{π}ᵢ)}ᵢ₌₁ⁿ, \vec{π}ₛᵤₘ).

In such embodiment, the messages mᵢ are comprised within the signature σ. In another embodiment, the messages mᵢ are not comprised within the signature σ. However, in such case, a correspondence table (stored in a memory unit) or a simple pre-determined lexicographical order enables to link each message mᵢ with the corresponding elements \vec{C}_{θ}_{_{i,1}}, \vec{C}_{θ}_{_{i,2}}, \vec{π}ᵢ.

In one embodiment, the structure preserving signature generated in the step 209 an be obtained by using the technique described in the article “Signing on Elements in Bilinear Groups for Modular Protocol Design” by M. Abe et al., and published in the Cryptology ePrint Archive, or the technique described in the article “Structure-Preserving Signatures and Commitments to Group Elements” by M. Abe et al., and published in the proceedings of the conference Crypto 2010.

In another embodiment, the step 212 comprises a step of decomposing x into n parts via the use of the Shamir's Secret Sharing technique (published in the article “How to Share a Secret”, by A. Shamir, Communications of the ACM, 22(11), p. 612-613, 1979). Indeed, the secret key x can be shared in a n-out-of-n fashion through such technique in such a way that homomorphic polynomial manipulations can be used to turn a n-out-of-n sharing into a (n+1)-out-of-(n+1) sharing of the same secret without knowing this secret. This was done in Section 6 of the article: “Attribute-Based Encryption for Fine-Grained Access Control of Encrypted Data” by V. Goyal et al., published in the Cryptology ePrint Archive (Report 2006/309). Then one skilled in the art would modify the step 213 accordingly. These remarks can also be applied to the embodiment described in the FIG. 3. FIG. 2(c) presents a derivation signature method noted SignDerive(pk, Msg, Msg′, σ), referenced 218, that can be executed by a device as the one depicted in the FIG. 1 and FIG. 4. Such derivation signature method 218 takes in input a set of messages Msg={mᵢ}ᵢ₌₁ⁿ comprising n messages, and another set of messages Msg′={mᵢ}ᵢ₌₁ⁿ ∪ {m′} for some m′ εΣ. In the case that the set Msg′ has not such format, the derivation signature method outputs a symbol ⊥ that indicates that it is not possible to derive a signature. Such derivation signature method comprises:
a step, referenced 219, of determining n+1 elements (ω′₁, . . . , ω′ₙ₊₁), chosen randomly in the group [symbol] ₚ with the constraint that Σᵢ₌₁ⁿ⁺¹ω′ᵢ=0;
a step, referenced 220, of determining for all the i ε {1, . . . , n} the followings values: \vec{C′}_{σ}_{_{i,1}}=(1, 1, [symbol] (mᵢ)^{ω′}^{ᵢ}). \vec{C}_{σ}_{_{i,1}} and \vec{C′}_{σ}_{_{i,2}}=(1, 1, g^{ω′}^{ᵢ}). \vec{C}_{σ}_{_{i,2}}. It should be noticed that the proof \vec{π}ᵢ=(π_{i,1}, π_{i,2}, π_{i,3}) still satisfies the equation E (g, \vec{C}′_{σ}_{_{i,1}})=E( [symbol] (mᵢ), \vec{C}′_{σ}_{_{i,2}}). E(π_{i,1}, \vec{f₁}). E(π_{i,2}, \vec{f₂}). E (π_{i,3}, \vec{f₃}), because it only depends on the randomness of commitments and not on the committed values;
a step, referenced 221, of determining σ_{n+1,1} and σ_{n+1,2} such that σ_{n+1,1}= [symbol] (m′)^{ω′}^{ₙ₊₁} and σ_{n+1,2}=g^{ω′}^{ₙ₊₁};
a step, referenced 222, of obtaining random values r_{n+1,1}, r_{n+1,2}, s_{n+1,1}, s_{n+1,2}, t_{n+1,1}, t_{n+1,2} in the group [symbol] ₚ;
a step, referenced 223 of determining commitments of σ_{n+1,1} and σ_{n+1,2}: \vec{C}_{σ}_{_{n+1,1}}=(1, 1, σ_{n+1,1}). \vec{f₁}^{r}^{_{n+1,1}}. \vec{f₂}^{s}^{_{n+1,1}}. \vec{f₃}^{t}^{_{n+1,1}} and \vec{C}_{σ}_{_{n+1,2}}=(1, 1, σ_{n+1,2}). \vec{f₁}^{r}^{_{n+1,2}}. \vec{f₂}^{s}^{_{n+1,2}}. \vec{f₃}^{t}^{_{n+1,2}};
a step, referenced 224, of determining NIWI proof \vec{π}ₙ₊ᵢ=(π_{n+1,1}, π_{n+1,2}, π_{n+1,3})=(g^{r}^{_{n+1,1}}. [symbol] (m′)^{-r}^{_{n+1,2}}, g^{s}^{_{n+1,1}}. [symbol] (m′)^{-s}^{_{n+1,2}}, g^{t}^{_{n+1,1}}. [symbol] (m′)^{-t}^{_{n+1,2}}), for certifying that the following equality stands: e(σ_{n+1,1}, g)=e( [symbol] (m′), σ_{n+1,2});
A step, referenced 225, of updating the proof sum by determining \vec{π}′ₛᵤₘ=(π′_{s,1}, π′_{s,2}, π′_{s,3})=(π_{s,1}. g^{-r}^{_{n+1,2}}, π_{s,2}. g^{-s}^{_{n+1,2}}, π_{s,2}. g^{-t}^{_{n+1,2}});
a step, referenced 226, of re-randomizing the commitments

$${{C}^{->}}_{X} , {\{ {{C}^{->}}_{{σ}_{i , 1}}^{′} , {{C}^{->}}^{′} \}}_{i + 1}^{n + 1}$$

$$and$$

$${\{ {{C}^{->}}_{{θ}_{j}} \}}_{j = 1}^{{l}_{sps}} ,$$

and the proofs {\vec{π}_{sps,j}}ⱼ₌₁^{ν}^{ₛₚₛ}, {\vec{π}ᵢ}ᵢ₌₁ⁿ and \vec{π}′ₛᵤₘ, delivering the following re-randomizing elements

$${{C}^{->}}_{X}^{″} , {\{ {{C}^{->}}_{{σ}_{i , 1}}^{″} , {{C}^{->}}_{{σ}_{i , 2}}^{″} \}}_{i = 1}^{n + 1}$$

$$and$$

$${\{ {{C}^{->}}_{{θ}_{j}}^{″} \}}_{j = 1}^{{l}_{sps}} ,$$

and the proofs {\vec{π}″_{sps,j}}ⱼ₌₁^{ν}^{ₛₚₛ}, {\vec{π}″ᵢ}ᵢ₌₁ⁿ and \vec{π}″ₛᵤₘ. In such step, in all of these commitments and proofs, the underlying exponents have been updated;
a step, referenced 227, of outputting a derived signature σ′ defined as follows:

$${σ}^{′} = ( {{C}^{->}}_{X}^{″} , {\{ {{C}^{->}}_{{θ}_{j}}^{″} \}}_{j = 1}^{{l}_{sps}} , {\{ {{π}^{->}}_{sps , j}^{″} \}}_{j = 1}^{{v}_{sps}} , {\{ ( {m}_{i} , {{C}^{->}}_{{σ}_{i , 1}}^{″} , {{C}^{->}}_{{σ}_{i , 2}}^{″} , {{π}^{->}}_{i}^{″} ) \}}_{i = 1}^{n + 1} , {{π}^{->}}_{sum}^{″} )$$

after having re-organized the indexation of {(mᵢ, \vec{C}″_{σ}_{_{i,1}}, \vec{C}″_{σ}_{_{i,2}}, \vec{π}″ᵢ)}ᵢ₌₁ⁿ⁺¹ according to the pre-determined lexicographical order for {mᵢ}ᵢ₌₁ⁿ⁺¹.

In another embodiment, the step 219 comprises a step of decomposing the value 0 into n+1 parts via the use of the Shamir's Secret Sharing technique in the same way as the technique already mentioned in the case of the decomposition of the secret key x can be divided into n part. Then one skilled in the art would modify the step 220 accordingly. These remarks can also be applied to the embodiment described in the FIG. 3.

FIG. 2(d) presents a verification signature method noted Verify(pk, Msg, σ), referenced 227, that can be executed by a device as the one depicted in the FIG. 1 and FIG. 4. Such verification signature method 228 takes in input a given public key pk, and a set of messages Msg={m₁}ᵢ₌₁ⁿ, with mᵢ εΣ={0,1}^{L}, and a signature σ. Such verification signature method comprises:
a step, referenced 229, of verify the format of the signature σ (e.g if σ can be expressed) as follows: σ=(\vec{C}_{X}, {\vec{C}_{θ}_{ⱼ}}ⱼ₌₁^{l}^{ₛₚₛ}, {\vec{π}_{sps,1}}ⱼ₌₁^{ν}^{ₛₚₛ}, {(mᵢ, \vec{C}_{σ}_{_{i,1}}, \vec{C}_{σ}_{_{i,2}}, \vec{π}ᵢ )}ᵢ₌₁ⁿ, πₛᵤₘ);
a step, referenced 230, f verifying if the proofs {\vec{π}_{sps,1}}ⱼ₌₁^{ν}^{ₛₚₛ} comprised in the signature σ satisfy the verification equations of the structure preserving signature. In the case that the proofs {\vec{π}_{sps,1}}ⱼ₌₁^{ν}^{ₛₚₛ} do not satisfy such equations, the step delivers an output value equals to zero;
a step, referenced 231, of determining if there is at least one element i ε {1, . . . , n} such that the proof \vec{π}ᵢ does not verify the equation E(g, \vec{C}_{σ}_{_{i,1}})=E( [symbol] (mᵢ),(\vec{C}_{σ}_{_{i,2}}).E(π_{i,1}, \vec{f₁}).E(π_{i,2}, \vec{f₂}).E(π_{i,3}, \vec{f₃}). In the case that such element i exists, the step delivers an output value equals to zero;
a step, referenced 232, of determining if the element \vec{π}ₛᵤₘ does not satisfy the equation E(g, \vec{C}_{X}. Πᵢ₌₁ⁿ\vec{C}_{σ}_{_{i,1}}⁻¹)=E(π_{s,1}, \vec{f₁}). E(π_{s,2}, \vec{f₂}). E(π_{s,3}, \vec{f₃}). In the case that such element \vec{π}ₛᵤₘ does not satisfy the equation, the step delivers an output value equals to zero;
In the case that one of the previously step has delivered an output value equals to zero, the verification signature method indicates that the signature is not valid. Otherwise, it indicates that the signature is valid.

In such embodiment, the elements {mᵢ}ᵢ₌₁ⁿ are comprised in the signature so as to simplify the verifier's task and help him to determine the signature components associated with each element of Msg when checking the equation:

E(g, \vec{C}_{σ}_{_{i,1}})=E( [symbol] (mᵢ), \vec{C}_{σ}_{_{i,2}})·E(π_{i,1}, \vec{f₁})·E(π_{i,2}, \vec{f₂})·E(π_{i,3}, \vec{f₃}).

As in the article “Cryptographic Methods for storing ballots on a voting machine” previously mentioned, one can finalize the set and prevent any further insertions by adding a special message.

FIGS. 3(a)-(d) present the main functions of a signature scheme according to one embodiment of the invention.

In the notations below, as previously mentioned, for any element h ε [symbol] and any vector \vec{g}=(g₁, g₂, g₃) ε [symbol] ³, E(h, \vec{g}) stands for the vector (e(h, g₁), e(h, g₂), e(h, g₃)) ε [symbol] _{T}³.

FIG. 3(a) presents a generation method noted Keygen(λ), referenced 300, that comprises:
a step, referenced 301, of obtaining a bilinear group ( [symbol] , [symbol] _{T}) of prime order p>2^{λ}, with a generator g randomly chosen in the group [symbol] ;
a step, referenced 302, of generating a Groth-Sahai CRS f=(\vec{f₁}, \vec{f₂}, \vec{f₃}) for the perfect witness indistinguishability setting, namely \vec{f₁}=(f₁, 1, g), \vec{f₂}=(1, f₂,g) and \vec{f₃}=\vec{f₁}^{ξ}^{₁}. \vec{f₂}^{ξ}^{₂}. (1, 1, g)⁻¹, with randomly chosen elements f₁ and f₂ in the group [symbol] , and values ξ₁ and ξ₂, randomly chosen values in [symbol] ₚ;
a step, referenced 303, of generating a key pair (skₐₕₒ, pkₐₕₒ) for an AHO signature (see the article “Signing on Elements in Bilinear Groups for Modular Protocol Design” previously mentioned for a definition of such signature scheme) in order to sign messages consisting of a single group element. The elements of the key pair are the following ones: pkₐₕₒ=(Gᵣ, Hᵣ, G_{z}, H_{z}, G₁, H₁, A, B), with G_{z}=Gᵣ^{γ}^{_{z}}, H_{z}=Hᵣ^{δ}^{_{z}}, G₁=Gᵣ^{γ}^{₁}, H₁=Hᵣ^{δ}^{₁}, and skₐₕₒ=(αₐ, α_{b}, γ_{z}, δ_{z}, γ₁, δ₁);
a step, referenced 304, of generating parameters for a Waters hash function. Such step of generating comprises:
   a step of obtaining L+1 random values (h₀, h₁, . . . , h_{L}) where each element hᵢ belongs to the group [symbol] ;
   a step of defining a function [symbol] :{0,1}^{L}→ [symbol] , such that for any L-bit string m=m[1] . . . m[L] ε{0,1}^{L}, we have [symbol] (m)=h₀. Πᵢ₌₁^{L}hᵢ^{m[i]};
a step, referenced 305, of outputting a public key pk which is defined as follows: pk=(( [symbol] , [symbol] _{T}), g, f, pkₐₕₒ, {hᵢ}ᵢ₌₀^{L}), and outputting a private key sk defined as follows: sk=skₐₕₒ. The public key defines Σ={0,1}^{L}.

FIG. 3(b) presents a signature method noted Sign(sk, Msg), referenced 306, that takes on input a message Msg={mᵢ}ᵢ₌₁ⁿ, where mᵢ ε {0,1}^{L} for each i, and the private key sk=skₐₕₒ. Such signature method comprises:
a step, referenced 307, of generating a fresh one-time public key X=g^{x}, with an element x which is chosen randomly in the group [symbol] ₚ;
a step, referenced 308, of generating Groth-Sahai commitments

$${\vec{C}}_{X} = ( 1 , 1 , X ) \cdot {\vec{f}}_{1}^{{r}_{X}} \cdot {\vec{f}}_{2}^{{s}_{X}} \cdot {\vec{f}}_{3}^{{t}_{X}}$$

with the elements r_{X}, s_{X} and t_{X} that are random values belonging to the group [symbol] ₚ;
a step, referenced 309, of generating an AHO signature (θ₁, . . . , θ₇) ε [symbol] ⁷on the group element X ε [symbol] ;
a step, referenced 310 of generating some Groth-Sahai commitments

$${\vec{C}}_{{θ}_{j}} = ( 1 , 1 , {θ}_{j} ) \cdot {\vec{f}}_{1}^{{r}_{{θ}_{j}}} \cdot {\vec{f}}_{2}^{{s}_{{θ}_{j}}} \cdot {\vec{f}}_{3}^{{t}_{{θ}_{j}}}$$

for j ε {1,2,5};
a step, referenced 311, of generating NIWI proofs \vec{π}_{aho,1} and \vec{π}_{aho,2} that committed variables satisfy the following two relationships:
A. e(θ₃, θ₄)⁻¹=e(G_{z}, θ₁). e(Gᵣ, θ₂). e(G₁, X) and
B. e(θ₆, θ₇)⁻¹=e(H_{z}, θ₁). e(Hᵣ, θ₅). e(H₁, X). In that case, the proofs are obtained as follows:

$${\vec{π}}_{aho , 1} = ( {G}_{z}^{- {r}_{{θ}_{1}}} {G}_{r}^{- {r}_{{θ}_{2}}} {G}_{1}^{- {r}_{X}} , {G}_{z}^{- {s}_{{θ}_{1}}} {G}_{r}^{- {s}_{{θ}_{2}}} {G}_{1}^{- {s}_{X}} , {G}_{z}^{- {t}_{{θ}_{1}}} {G}_{r}^{- {t}_{{θ}_{2}}} {G}_{1}^{- {t}_{X}} )$$

$$and$$

$${\vec{π}}_{aho , 2} = ( {H}_{z}^{- {r}_{{θ}_{1}}} {H}_{r}^{- {r}_{{θ}_{5}}} {H}_{1}^{- {r}_{X}} , {H}_{z}^{- {s}_{{θ}_{1}}} {H}_{r}^{- {s}_{{θ}_{5}}} {H}_{1}^{- {s}_{X}} , {H}_{z}^{- {t}_{{θ}_{1}}} {H}_{r}^{- {t}_{{θ}_{5}}} {H}_{1}^{- {t}_{X}} ) ;$$

a step, referenced 312, of determining n elements of the group [symbol] ₚ(ω₁, . . . , ωₙ), satisfying the following constraint: Σᵢ₌₁ⁿωᵢ=x;
a step, referenced 313, of determining for all the i ε {1, . . . , n} the followings values: σ_{i,1}= [symbol] (mᵢ)^{ω}^{ᵢ} and σ_{1,2}=g^{ω}^{ᵢ}, where the messages are indexed in some pre-determined lexicographical order;
a step, referenced 314, of determining commitments of said values σ_{i,1} and σ_{i,2} as follows:

$${\vec{C}}_{{σ}_{i , 1}} = ( 1 , 1 , {σ}_{i , 1} ) \cdot {\vec{f}}_{1}^{{r}_{i , 1}} \cdot {\vec{f}}_{2}^{{s}_{i , 1}} \cdot {\vec{f}}_{3}^{{t}_{i , 1}}$$

$$and$$

$${\vec{C}}_{{σ}_{i , 2}} = ( 1 , 1 , {σ}_{i , 2} ) \cdot {\vec{f}}_{1}^{{r}_{i , 2}} \cdot {\vec{f}}_{2}^{{s}_{i , 2}} \cdot {\vec{f}}_{3}^{{t}_{i , 2}} ,$$

for all the elements σ_{i,1} and σ_{i,2} that belong to the set {σ_{i,1}, σ_{i,2}}ᵢ₌₁ⁿ;
a step, referenced 315, of generating for all i ε {1, . . . , n} , a NIWI proof \vec{π}ᵢ proving that the elements σ_{i,1} and σ_{i,2} satisfy the equation e(σ_{i,1}, g)=e( [symbol] (mᵢ), σ_{i,2}). Such proof \vec{π}ᵢ is obtained by performing the followings computations: \vec{π}ᵢ=(π_{i,1 , π}_{i,2}, π_{i,3})=(g^{r}^{_{i,1}}. [symbol] (mᵢ)^{-r}^{_{i,2}}, g^{s}^{_{i,2}}. [symbol] (mᵢ)^{-s}^{_{i,2}}, g^{t}^{_{i,1}}. [symbol] (mᵢ)^{-t}^{_{i,2}}), and satisfying the following equation: E=(g, \vec{C}_{σ}_{_{i,1}})=E( [symbol] (mᵢ), \vec{C}_{σ}_{_{i,2}}. E(π_{i,1}, \vec{f₁}). E(π_{i,2}, \vec{f₂}). E(π_{i,3}, \vec{f₃}).
a step, referenced 316, of determining a NIWI proof \vec{π}ₛᵤₘ, that X=Πᵢ₌₁ⁿσ_{i,2}. Such proof is obtained by performing the following computations:

$$\begin{matrix}{{π}^{}}_{sum} = ( {π}_{s , 1} , {π}_{s , 2} , {π}_{s , 3} ) \\ = ( {g}^{{r}_{X} - {\sum }_{i = 1}^{n} {r}_{i , 2}} , {g}^{{s}_{X} - {\sum }_{i = 1}^{n} {s}_{i , 2}} , {g}^{{t}_{X} - {\sum }_{i = 1}^{n} {t}_{i , 2}} ) ,\end{matrix}$$

which satisfies the equation

E(g,\vec{C}_{X}·Πᵢ₌₁ⁿ\vec{C}_{σ}_{_{i,1}}⁻¹)=E(π_{s,1},\vec{f₁})·E(π_{s,2},\vec{f₂})·E(π_{s,3}, \vec{f₃});
a step, referenced 317, of outputting the signature σ associated to the set of message Msg={mᵢ}ᵢ₌₁ⁿ defined as:

σ=(\vec{C}_{X}, {\vec{C}_{σ}_{ⱼ}}_{jε{1,2,5}}, {σⱼ}_{jε{3,4,6,7}}, \vec{π}_{aho,1}, \vec{π}_{aho,2}, {(mᵢ, \vec{C}_{σ}_{_{i,1}}, \vec{C}_{σ}_{_{i,2}}, \vec{π}ᵢ)}ᵢ₌₁ⁿ, \vec{π}ₛᵤₘ).

FIG. 3(c) presents a derivation signature method noted SignDerive(pk, Msg, Msg′, σ), referenced 318, that takes in input a set of messages Msg={mᵢ}ᵢ₌₁ⁿ comprising n messages, and another set of messages Msg′={mᵢ}ᵢ₌₁ⁿ ∪ {m′} for some m′ ε Σ. In the case that the set Msg′ has not such format, the derivation signature method outputs a symbol ⊥ that indicates that it is not possible to derive a signature. Such derivation signature method comprises:
A step, referenced 319, of re-randomizing the commitment \vec{C}_{X} and the proofs \vec{π}_{aho,1}, \vec{π}_{aho,2} and \vec{π}ₛᵤₘ, delivering the re-randomized commitment \vec{C}_{X}″, and the proofs \vec{π}′_{aho,1}, \vec{π}′_{aho,2} and \vec{π}′ₛᵤₘ. It should be noticed that in these commitments and proofs, the underlying values r_{X}, s_{X} and t_{X} have been updated;
A step, referenced 320, of re-randomizing the commitments

$${\{ {{C}^{->}}_{{θ}_{j}} \}}_{j ∈ \{ 1 , 2 , 5 \}}$$

and {θⱼ}_{jε{3,4,6,7}} by choosing σ₂, σ₅, μ, υ and computing the followings elements: \vec{C}′_{θ}_{₂}=\vec{C}_{θ}_{₂}. (1, 1, θ₄^{σ}^{₂}), \vec{C}′_{θ}_{₅}=\vec{C}_{θ}_{₅}. (1, 1, θ₇^{σ}^{₅}), θ′₃=(θ₃. Gᵣ^{-σ}^{₂})^{1/μ}, θ′₆=(θ₆. Hᵣ^{-σ}^{₅})^{1/υ}, θ′₄=θ₄^{μ}, and θ′₇=θ₇^{υ}. Although the committed values inside \vec{C}′_{θ}_{₂} and \vec{C}′₇₄ _{₅} have been updated, \vec{π}′_{aho,1}, \vec{π}′_{aho,2} are still valid proofs for the new committed values;
A step, referenced 321, of determining

$${\{ {{C}^{->}}_{{θ}_{j}}^{″} \}}_{j ∈ \{ 1 , 2 , 5 \}}$$

by re-randomizing the commitments

$${{C}^{->}}_{{θ}_{1}} , {\{ {{C}^{->}}_{{θ}_{j}}^{′} \}}_{j ∈ \{ 2 , 5 \}}$$

and the proofs \vec{π}′_{aho,1}, \vec{π}′_{aho,2} again. Such step delivers \vec{π}″_{aho,1}, \vec{π}″_{aho,2} that are the re-randomized proofs;
A step, referenced 322, of determining n+1 elements (ω′₁, . . . , ωₙ₊₁), chosen randomly in the group [symbol] ₚ with the constraint that Σᵢ₌₁ⁿ⁺¹ω′ᵢ₌0;
A step, referenced 323, of determining for all the i ε {1, . . . , n} the followings values: \vec{C′}_{σ}_{_{i,1}}=(1, 1, [symbol] (mᵢ)^{ω′}^{ᵢ}). \vec{C}_{σ}_{_{i,1}} and \vec{C}′_{σ}_{_{i,2}}=(1, 1,g^{ω′}^{ᵢ}). \vec{C}_{σ}_{_{i,2}}. It should be noticed that the proof \vec{π}ᵢ=(π_{i,1}, π_{i,2}, π_{i,3}) still satisfies the equation E(g, \vec{C}′_{σ}_{_{i,1}})=E( [symbol] (mᵢ), \vec{C}′_{σ}_{_{i,2}}). E(π_{i,1}, \vec{f₁}). E(π_{i,2}, \vec{f₂}). E(π_{i,3}, \vec{f₃}), because it only depends on the randomness of commitments and not on the committed values;
A step, referenced 324, of determining σ_{n+1,1} and σ_{n+1,2} such that σ_{n+1,1}= [symbol] (m′)^{ω′}^{ₙ₊₁} and σ_{n+1,2}=g^{ω′}^{ₙ₊₁};
A step, referenced 325, of obtaining random values r_{n+1,1}, r_{n+1,2}, s_{n+1,1}, s_{n+1,2}, t_{n+1,1}, t_{n+1,2} in the group [symbol] ₚ;
A step, referenced 326, of determining commitments of σ_{n+1,1} and σ_{n+1,2}:\vec{C}_{σ}_{_{n+1,1}}=(1, 1, σ_{n+1,1})·\vec{f₁}^{r}^{_{n+1,1}}·\vec{f₂}^{s}^{_{n+1,1}}·\vec{f₃}^{t}^{_{n+1,1}} and \vec{C}_{σ}_{_{n+1,2}}=(1, 1, σ_{n+1,2}). \vec{f₁}^{r}^{_{n+1,2}}. \vec{f₂}^{s}^{_{n+1,2}}. \vec{f₃}^{t}^{_{n+1,2}};
A step, referenced 327, of determining NIWI proof \vec{π}ₙ₊₁=(π_{n+1,1}, π_{n+1,2}, π_{n+1,3})=(g^{r}^{_{n+1,1}}. [symbol] (m′)^{-r}^{_{n+1,2}}, g^{s}^{_{n+1,1}}. [symbol] (m′)^{-s}_{is+1,2}, g^{t}^{_{n+1,1}}. [symbol] (m′)^{-t}^{_{n+1,2}} for certifying that the following equality stands: e(σ_{n+1,1}, g)=e( [symbol] (m′), σ_{n+1,2}); −A step, referenced 328, of updating the proof sum by determining \vec{π}″ₛᵤₘ=(π″_{s,1}, π″_{s,2}, π″_{s,3})=(π′_{s,1}. g^{-r}^{_{n+1,2}}, π′_{s,2}. g^{-s}^{_{n+1,2}}, π′_{s,2}. g^{-t}^{_{n+1,2}});
A step, referenced 329, of re-randomizing

$${\{ {{C}^{->}}_{{σ}_{i , 1}}^{′} , {{C}^{->}}_{{σ}_{i , 2}}^{′} \}}_{i = 1}^{n + 1}$$

and {\vec{π}ᵢ}ᵢ₌₁ⁿ⁺¹, and \vec{π}″ₛᵤₘ delivering

$${\{ {{C}^{->}}_{{σ}_{i , 1}}^{″} , {{C}^{->}}_{{σ}_{i , 2}}^{″} \}}_{i = 1}^{n + 1}$$

and {\vec{π}″ᵢ}ᵢ₌₁ⁿ⁺¹, and \vec{π}′″ₛᵤₘ;
A step, referenced 330, of outputting a derived signature σ′ defined as follows:

$${σ}^{′} = ( {{C}^{->}}_{X}^{″} , {\{ {{C}^{->}}_{{θ}_{j}}^{′} \}}_{j ∈ \{ 1 , 2 , 5 \}} , {\{ {θ}_{j} \}}_{j ∈ \{ 3 , 4 , 6 , 7 \}} , {{π}^{->}}_{aho , 1}^{″} , {{π}^{->}}_{aho , 2}^{″} , {\{ ( {m}_{i} , {{C}^{->}}_{{σ}_{i , 1}}^{″} , {{C}^{->}}_{{σ}_{i , 2}}^{″} , {{π}^{->}}_{i}^{″} ) \}}_{i = 1}^{n + 1} , {{π}^{->}}_{sum}^{′′′} )$$

after having re-organized the indexation of {(mᵢ, \vec{C}″_{σ}_{_{i,1}}, \vec{C}″_{σ}_{_{i,2}}, \vec{π}″ᵢ)}ᵢ₌₁ⁿ⁺¹ according to the pre-determined lexicographical order for {mᵢ}ᵢ₌₁ⁿ⁺¹.

FIG. 3(d) presents a verification signature method noted Verify(pk, Msg, σ), referenced 331, that takes in input a given public key pk, and a set of messages Msg={mᵢ}ᵢ₌₁ⁿ, with mᵢ ε Σ={0,1}^{L}, and a signature σ. Such verification signature method comprises:
A step, referenced 332, of verify the format of the signature σ (e.g if σ can be expressed as follows

$$σ = ( {{C}^{->}}_{X} , {\{ {{C}^{->}}_{{θ}_{j}} \}}_{j ∈ \{ 1 , 2 , 5 \}} , {\{ {θ}_{j} \}}_{j ∈ \{ 3 , 4 , 6 , 7 \}} , {{π}^{->}}_{aho , 1} , {{π}^{->}}_{aho , 2} , {\{ ( {m}_{i} , {{C}^{->}}_{{σ}_{i , 1}} , {{C}^{->}}_{{σ}_{i , 2}} , {{π}^{->}}_{i} ) \}}_{i = 1}^{n} , {{π}^{->}}_{sum} ) ;$$

A step, referenced 333, of verifying if the proofs \vec{π}_{aho,1}=(π₁, π₂, π₃) and \vec{π}_{aho,2}=(π₄, π₅, π₆) comprised in the signature a satisfy the following two equations:

1 [symbol] _{_{T}}, 1 [symbol] _{_{T}}A)·E(θ₃,(1,1,θ₄))¹=E(G_{z},\vec{C}_{θ}_{₁})·E(Gᵣ,\vec{C}_{θ}_{₂})·E(G₁,\vec{C}_{X})·Πⱼ₌₁³E(πⱼ,\vec{f}ⱼ) and

1 [symbol] _{_{T}}, 1 [symbol] _{_{T}}B)·E(θ₆,(1,1,θ₇))¹=E(H_{z},\vec{C}_{θ}_{₁})·E(Hᵣ,\vec{C}_{θ}_{₅})·E(H₁,\vec{C}_{X})·Πⱼ₌₁³E(πⱼ₊₃,\vec{f}ⱼ)

In the case that the proofs \vec{π}_{aho,1}, \vec{π}_{aho,2} do not satisfy such equations, the step delivers an output value equals to zero;
A step, referenced 334, of determining if there is at least one element i ε {1, . . . , n} such that the proof \vec{π}ᵢ does not verify the equation E(g, \vec{C}_{σ}_{_{i,1}})=E( [symbol] (mᵢ),\vec{C}_{σ}_{_{i,2}}). E(π_{i,1}, \vec{f₁}). E(π_{i,2}, \vec{f₂}).E(π_{i,3}, \vec{f₃}). In the case that such element i exists, the step delivers an output value equals to zero;
A step, referenced 335, of determining if the element \vec{π}ₛᵤₘ does not satisfy the equation E(g, \vec{C}_{X}. Πᵢ₌₁ⁿ\vec{C}_{σ}_{_{i,1}}⁻¹)=E(π_{s,1}, \vec{f₁}). E(π_{s,2}, \vec{f₂}). E(π_{s,3}, \vec{f₃}). In the case that such element \vec{π}ₛᵤₘ does not satisfy the equation, the step delivers an output value equals to zero;
In the case that one of the previously step has delivered an output value equals to zero, the verification signature method indicates that the signature is not valid. Otherwise, it indicates that the signature is valid.

In the construction, a set of messages Msg={mᵢ}ᵢ₌₁ⁿ having a cardinality n can be signed₁ using 9n+25 group elements. The messages are included in the signature so as to simplify the verifier's task and help him determine the signature components associated with each element of Msg when checking the equality

E(g,\vec{C}_{σ}_{_{i,1}})=E( [symbol] (mᵢ),\vec{C}_{σ}_{_{i,2}})·E(π_{i,1},\vec{f₁})·E(π_{i,2},\vec{f₂})·E(π_{i,3},\vec{f₃}).

In comparison with the technique described in the previously mentioned article “Cryptographic Methods for Storing Ballots on a Voting Machine” by J. Bethencourt et al., such scheme only inflates signatures by a constant factor.

Moreover, such scheme is clearly unconditionally completely context-hiding (and thus subliminal free) because, except {mᵢ}ᵢ₌₁ⁿ (which are re-ordered to appear in lexicographical order at each derivation), signatures only consist of perfectly hiding commitments and NIWI proofs. Moreover, these are perfectly re-randomizable at each signature derivation. We also have a mathematical proof that the scheme is unforgeable in the standard model (i.e., without modeling hash functions as oracles) if the DLIN and q-SFP assumptions (see the article “Computing on Authenticated data: New Privacy Definitions and Constructions” previously mentioned for a definition of the DLIN and q-SFP assumptions) both hold in the group [symbol] . The scheme is thus validated by an actual proof “in the real world”, rather than a heuristic argument like the random oracle model.

FIG. 4 presents a device that can be used to perform one or several steps of methods disclosed in the present document.

Such device referenced 400 comprise a computing unit (for example a CPU, for “Central Processing Unit”), referenced 401, and one or several memory units (for example a RAM (for “Random Access Memory”) block in which intermediate results can be stored temporarily during the execution of instructions a computer program, or a ROM block in which, among other things, computer programs are stored, or an EEPROM (“Electrically-Erasable Programmable Read-Only Memory”) block, or a flash block) referenced 402. Computer programs are made of instructions that can be executed by the computing unit. Such device 400 can also comprise a dedicated unit, referenced 403, constituting an input-output interface to allow the device 400 to communicate with other devices. In particular, this dedicated unit 403 can be connected with an antenna (in order to perform communication without contacts), or with serial ports (to carry communications “contact”). Let's remark that the arrows in FIG. 4 means that the linked unit can exchange data through buses for example together.

In an alternative embodiment, some or all of the steps of the method previously described, can be implemented in hardware in a programmable FPGA (“Field Programmable Gate Array”) component or ASIC (“Application-Specific Integrated Circuit”) component.

In an alternative embodiment, some or all of the steps of the method previously described, can be executed on an electronic device comprising memory units and processing units as the one disclosed in the FIG. 4.

1. Method for signing a set of binary elements comprising n elements, where n is an integer, by an electronic device, wherein it comprises:
obtaining a one-time key pair comprising a private key corresponding to a random integer, and a public key corresponding to an element of a group raised to the power of said random integer;
signing said public key with a structure-preserving signature method, delivering a first signature;
obtaining a first commitment on said public key, a second commitment on said first signature and a first non-interactive witness proof that said public key and said first signature verify equations of the structure preserving signature;
obtaining a decomposition of said private key into a sum of n random integer, each random integer been associated to only one element of said set;
signing each element in said set in function of a programmable hash function and a random integer which is associated to it, delivering, for each element in said set, a second signature comprising at least a first and a second elements, a combination of all of said second elements being linked to said public key;
obtaining a third commitment on said first element, and a fourth commitment on said second element, for each second signature;
obtaining a second non-interactive witness proof that a relationship exists between said first element and said second element;
obtaining a third non-interactive witness proof that asserts that said combination of all of said second elements is being linked to said public key holds;
outputting a signature of said set of binary elements comprising said first, second commitments, said first non-interactive witness proof, said third non-interactive witness proof, and for each binary element of said set, said third, fourth commitments and said second non-interactive witness proof.

2. Method for signing according to claim 1, wherein said first, second, third and fourth commitments are Groth-Sahai commitments.

3. Method for signing according to claim 1, wherein said programmable hash function is a Waters hash function.

4. Method for signing according to claim 1, wherein said random integer x is comprised between zero and a prime number p, and said public key corresponds to X=g^{x}, where g is said element of said group.

5. Method for signing according to claim 4, wherein signing each element comprises:
obtaining said at least first element by determining a value σ_{i,1}= [symbol] (mᵢ)^{ω}^{ᵢ}, where [symbol] is said programmable hash function, mᵢ is an element of said set of binary elements, and ωᵢ is said random integer associated to said element mᵢ;
obtaining said at least second element by determining a value σ_{i,2}=g^{ω}^{ᵢ};
and in that said combination corresponds to a product of all the n values σ_{i,2} that is equal to said public key.

6. Method for signing according to claim 5, wherein said relationship between said first element σ_{i,1} and said second element σ_{i,2} is the following one e(σ_{i,1}, g)=e( [symbol] (mᵢ),σ_{i,2}).

7. Method for updating, by an electronic device, a signature of a set of binary elements comprising n elements, where n is an integer, wherein it comprises:
verifying that said signature of said set of binary elements comprises a first and a second commitment, a first non-interactive witness proof, a third non-interactive witness proof, and for each binary element of said set, a third and a fourth commitments and a second non-interactive witness proof;
adding k binary elements to said set, where k is an integer, delivering an updated set of binary elements comprising n+k elements that are different from each other;
obtaining n+k random integer, each random integer been associated to only one element of said set, and a sum of said n+k random integer being equal to zero;
modifying for each binary element of said set, said third and said fourth commitments in function of a random integer associated to a binary element;
determining for each of the k binary added elements, a first signature comprising at least a first and a second element in function of a programmable hash function and a random integer which is associated to it;
determining for each first signature a fifth commitment on said at least a first element, a sixth commitment on said at least a second element, and a fourth non-interactive witness proof that a relationship exists between said first element and said second element, said fifth and sixth commitments corresponding to said third and fourth commitments for said k additional elements, and said fourth non-interactive witness proof corresponding to said second non-interactive witness proof for said k additional elements;
updating said third non-interactive witness proof;
re-randomizing commitments and proofs.

8. Method for updating according to claim 7, wherein all commitments are Groth-Sahai commitments.

9. Method for updating according to claim 7, wherein said programmable hash function is a Waters hash function.

10. A computer-readable and non-transient storage medium storing a computer program comprising a set of computer-executable instructions to implement a method for cryptographic computations when the instructions are executed by a computer, wherein the instructions comprise instructions, which when executed, configure the computer to perform a method for signing a set of binary elements comprising n elements, where n is an integer, wherein it comprises:
obtaining a one-time key pair comprising a private key corresponding to a random integer, and a public key corresponding to an element of a group raised to the power of said random integer;
signing said public key with a structure-preserving signature method, delivering a first signature;
obtaining a first commitment on said public key, a second commitment on said first signature and a first non-interactive witness proof that said public key and said first signature verify equations of the structure preserving signature;
obtaining a decomposition of said private key into a sum of n random integer, each random integer been associated to only one element of said set;
signing each element in said set in function of a programmable hash function and a random integer which is associated to it, delivering, for each element in said set, a second signature comprising at least a first and a second elements, a combination of all of said second elements being linked to said public key;
obtaining a third commitment on said first element, and a fourth commitment on said second element, for each second signature;
obtaining a second non-interactive witness proof that a relationship exists between said first element and said second element;
obtaining a third non-interactive witness proof that asserts that said combination of all of said second elements is being linked to said public key holds;
outputting a signature of said set of binary elements comprising said first, second commitments, said first non-interactive witness proof, said third non-interactive witness proof, and for each binary element of said set, said third, fourth commitments and said second non-interactive witness proof.

11. A computer-readable and non-transient storage medium storing a computer program comprising a set of computer-executable instructions to implement a method for cryptographic computations when the instructions are executed by a computer, wherein the instructions comprise instructions, which when executed, configure the computer to perform a method for updating a signature of a set of binary elements comprising elements, where n is an integer, wherein it comprises:
verifying that said signature of said set of binary elements comprises a first and a second commitment, a first non-interactive witness proof, a third non-interactive witness proof, and for each binary element of said set, a third and a fourth commitments and a second non-interactive witness proof;
adding k binary elements to said set, where k is an integer, delivering an updated set of binary elements comprising n+k elements that are different from each other;
obtaining n+k random integer, each random integer been associated to only one element of said set, and a sum of said n+k random integer being equal to zero;
modifying for each binary element of said set, said third and said fourth commitments in function of a random integer associated to a binary element;
determining for each of the k binary added elements, a first signature comprising at least a first and a second element in function of a programmable hash function and a random integer which is associated to it;
determining for each first signature a fifth commitment on said at least a first element, a sixth commitment on said at least a second element, and a fourth non-interactive witness proof that a relationship exists between said first element and said second element, said fifth and sixth commitments corresponding to said third and fourth commitments for said k additional elements, and said fourth non-interactive witness proof corresponding to said second non-interactive witness proof for said k additional elements;
updating said third non-interactive witness proof;
re-randomizing commitments and proofs.

12. Electronic device comprising a module configured to sign a set of binary elements comprising n elements, where n is an integer, wherein said module comprises:
a module configured to obtain a one-time key pair comprising a private key corresponding to a random integer, and a public key corresponding to an element of a group raised to the power of said random integer;
a module configured to sign said public key with a structure-preserving signature means, delivering a first signature;
a module configured to obtain a first commitment on said public key, a second commitment on said first signature and a first non-interactive witness proof that said public key and said first signature verify equations of the structure preserving signature;
a module configured to obtain a decomposition of said private key into a sum of n random integer, each random integer been associated to only one element of said set;
a module configured to sign each element in said set in function of a programmable hash function and a random integer which is associated to it, delivering, for each element in said set, a second signature comprising at least a first and a second elements, a combination of all of said second elements being linked to said public key;
a module configured to obtain a third commitment on said first element, and a fourth commitment on said second element, for each second signature;
a module configured to obtain a second non-interactive witness proof that a relationship exists between said first element and said second element;
a module configured to obtain a third non-interactive witness proof that asserts that said combination of all of said second elements is being linked to said public key holds;
a module configured to output a signature of said set of binary elements comprising said first, second commitments, said first non-interactive witness proof, said third non-interactive witness proof, and for each binary element of said set, said third, fourth commitments and said second non-interactive witness proof.

13. Electronic device according to claim 11, wherein said first, second, third and fourth commitments are Groth-Sahai commitments.

14. Electronic device according to claim 11, wherein said programmable hash function is a Waters hash function.

15. Electronic device comprising a module configured to update a signature of a set of binary elements comprising n elements, where n is an integer, wherein it comprises:
a module configured to verify that said signature of said set of binary elements comprises a first and a second commitment, a first non-interactive witness proof, a third non-interactive witness proof, and for each binary element of said set, a third and a fourth commitments and a second non-interactive witness proof;
a module configured to add k binary elements to said set, where k is an integer, delivering an updated set of binary elements comprising n+k elements that are different from each other;
a module configured to obtain n+k random integer, each random integer been associated to only one element of said set, and a sum of said n+k random integer being equal to zero;
a module configured to modify for each binary element of said set, said third and said fourth commitments in function of a random integer associated to a binary element;
a module configured to determine for each of the k binary added elements, a first signature comprising at least a first and a second element in function of a programmable hash function and a random integer which is associated to it;
a module configured to determine for each first signature a fifth commitment on said at least a first element, a sixth commitment on said at least a second element, and a fourth non-interactive witness proof that a relationship exists between said first element and said second element, said fifth and sixth commitments corresponding to said third and fourth commitments for said k additional elements, and said fourth non-interactive witness proof corresponding to said second non-interactive witness proof for said k additional elements;
a module configured to update said third non-interactive witness proof;
a module configured to re-randomize commitments and proofs.

16. Electronic device according to claim 14, wherein all commitments are Groth-Sahai commitments.
